(19) United States
(12) Patent Application Publication
(10) Pub. No.: US 2004/0179230 A1
(43) Pub. Date: Sep. 16, 2004

(54) Distributed printing system, method, program, printer and printer management server

(76) Inventors: Naruhide Kitada, Nagano-Ken (JP); Taro Ishige, Beppu-shi (JP)

Correspondence Address: HARNESS, DICKEY & PIERCE, P.L.C., P.O. BOX 828, BLOOMFIELD HILLS, MI, 48303, US

(21) Appl. No.: 10/747,817

(22) Filed: Dec. 29, 2003

(30) Foreign Application Priority Data
Dec. 27, 2002 (JP) 2002-379,956
Nov. 19, 2003 (JP) 2003-388,845

(51) Int. Cl. G06F 15/00

(52) U.S. Cl. 358/1.15; 358/1.13

(57) ABSTRACT

A novel distributed printing system, method, program, printer and server are provided that provide optimum distributed printing without problems such as a backlog of print jobs in a print queue. A distributed print request is broadcasted to all printers and the most appropriate printer is selected from among responding printers on the basis of their printing capabilities and status information to assign the print job. Thus, the optimum printer can be selected without having to constantly monitor the capabilities and status of all printers. Furthermore, because status information such as the number of remaining paper sheets, in addition to printing capabilities, is used as criteria to select a printer, distributed printing can properly be scheduled without a backlog of pint jobs in a print queue.

### BACKGROUND OF THE INVENTION

1. Field of the Invention

The present invention relates to a distributed printing system, method, program, printer and printer management server for efficiently printing a large amount of data in a distributed manner.

2. Description of the Related Art

It is commonplace to use distributed printing technology in which a number of printers are used in parallel in order to print a large amount of data in a short time. In order to implement such distributed printing, a server that manages distributed printing must be provided and the server must always monitor the properties and status of each individual printer to appropriately distribute printing tasks among printers, as described in Japanese Patent Laid-Open No. 2001-134400.

However, it is difficult for a server that manages distributed printing to keep track of the properties, such as constantly varying status information, e.g., print capabilities and the status of each printer or the size and the number of paper sheets loaded and the ink level of each printer on the real time basis.

One approach to solving the problem may be the one in which a print management server does not constantly keep track of the properties and status of each printer, but instead each printer actively obtains a print request from a print management server, rather than the print management, as described in Japanese Patent No. 3106833 (Japanese Patent Laid-Open No. 7-200207.

However, with these approaches, a destination printer to which a print request is to be sent is determined before a print job is stored in a print queue and, therefore, if trouble such as a paper jam or paper out occurs in a target printer, jobs stuck in a print queue cannot be sent to that printer, which prevents optimum distributed printing.

The present invention has been made in light of these unresolved problems with the related art and an object of the present invention is to provide a novel distributed printing system, method, program, printer and printer management server that provide optimum distributed printing without problems such as a backlog of print jobs in a print queue.

### SUMMARY OF THE INVENTION

Aspect 1 provides a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the distributed print management server identifies one of the print jobs to be printed, provides a distributed print start notification to the printers, selects from among printers that have issued an acquisition request for the identified print job a printer that is appropriate for the identified job on the basis of printing capabilities and status information of the printer, and assigns the identified print job to the selected printer.

This configuration allows the distributed print management server to select an optimum printer without having to constantly monitor the capabilities and status of each printer. Furthermore, distributed printing can properly be scheduled without a backlog of print jobs because the printer is selected on the basis of not only the printing capabilities information but also the status information such as the number of remaining paper sheets and ink level of the printers.

Consequently, distributed printing of a large quantity of documents can efficiently be performed even if printers installed vary in terms of printing capabilities and status.

The term “distributed print request” herein refers to a request to perform a printing process in which one print job is divided into a number of jobs and the jobs are printed concurrently on a number of printers. There is no limitation on the manner in which a job is divided. In a typical example, a job of 10 pages may be divided into two jobs each consisting of 5 pages, or if a number of copies of a document are printed, the job may be divided into jobs for the individual copies.

The term “issue” herein is synonymous with “provide” and “send.”

The term “print job” herein means “data that allows a printer to perform printing.” In particular, the term refers to information including an instruction code for controlling printing, pixel information (bitmap information such as RGB and binarized information indicating the positions of dots, for example), characters, and image information such as graphics).

Aspect 2 provides a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the printers receive a print start notification from the distributed print management server and, if the printers are available for printing, provide a print job acquisition request for the print job to the distributed print management server along with the printing capability information and status information of the printers; and the distributed print management server identifies one of the print jobs to be printed from the print job holding portion, provides the print start notification to all or some of the plurality of printers, selects from among printers that have issued the print job acquisition request a printer that is appropriate for the print job on the basis of the printing capabilities and status information of the printers, and assigns the print job to the printer.

Like aspect 1, this configuration allows the distributed print management server to select an optimum printer without having to constantly monitor the capabilities and status of each printer. Furthermore, distributed printing can properly be scheduled without a backlog of print jobs in the print queue because the printer is selected on the basis of not only the printing capabilities information but also the status information such as the number of remaining paper sheets and ink level of the printers.

Consequently, distributed printing of a large quantity of documents can efficiently be performed even if printers installed vary in terms of printing capabilities and status.

Aspect 3 provides a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the printers receive a print start notification from the distributed print management server and, if the printers are available for printing, provide a print job acquisition request for the print job to the distributed print management server along with the printing capability information and status information of the printers; and each time the distributed print management server obtains one or more print jobs from the print job holding portion, the distributed print management server provides the distributed print start notification to all or some of the plurality of printers, selects one or more printers that complete the print job. in the shortest time from warm-up from among printers that have issued the print job acquisition request, on the basis of printing capabilities and the status information of the printer, and assigns the print jobs to the printers.

According to aspect 3, the printer “that can complete a print job in the shortest time from warm-up” is selected as the optimum printer on the basis of printing capabilities and status information. Therefore, aspect 3 has the effect that a large amount of data can be printed in a short time, in addition to the effects of aspect 1.

The term “warm-up” herein refers to a series of operations required for a printer to actually start printing, which includes but not limited to, initialization of the printer (such as initialization a counter in memory), heating of toner fixer by a heater, engine adjustments, head position adjustments (in an ink-jet printer), paper feeding, and finding the beginning of paper (in an ink-jet printer).

Aspect 4 provides a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the printers receive a print start notification from the distributed print management server and, if the printers are available for printing, provide a print job acquisition request for the print job to the distributed print management server along with the printing capability information and status information of the printers; and each time the distributed print management server obtains a print job from the print job holding portion, the distributed print management server provides the distributed print start notification to all or some of the plurality of printers, selects a printer that completes the print job in the shortest time from print data reception from among printers that have issued the print job acquisition request, on the basis of printing capabilities and the status information of the printer, and assigns the print job to the printer.

According to aspect 4, the printer “that can complete a print job in the shortest time from print data reception” is selected as the optimum printer on the basis of printing capabilities and status information. Therefore, aspect 4 has the effect that a large amount of data can be printed in a short time, in addition to the effects of aspect 1.

Aspect 5 provides a distributed printing system comprising a print instruction device that issues a distributed print request based on print data, a distributed print management server that divides the print data into a plurality of print jobs according to the distributed print request and stores the print jobs in a print job holding portion, and a plurality of printers. that acquire the print jobs from the distributed print management server and performs printing, wherein: each of the printer sends a print job acquisition request for the print job to the distributed print management server along with printing capability information and status information of the printer if the printer is available for printing; and each time the distributed print management server obtains a print job from the print job holding portion, the distributed print management server selects printers that are available for printing from among printers that have issued the print job acquisition request, selects a printer that is appropriate for the print job from among the selected printers on the basis of printing capabilities and the status information of the printer, and assigns the print job to the printer.

Thus, aspect 1 and aspect 2, each printer first receives a distribution print start notification from the distributed print management server and then, if the printer determines that the printer is available for printing, provides a print job acquisition request to the distributed print management server, whereas, in aspect 5, each printer autonomously provides a print job acquisition request to the distributed print management sever along with printing capability information of the printer if the printer determines it is available for printing whether or not a distributed print start notification is provided from the distributed print management server.

Thus, the frequency of notifications from the distributed print management server to each printer is reduced and waiting time of printers is also reduced. Consequently, the printers can be effectively used without waste.

Aspect 6 provides the distributed printing system according to any of aspect 1 to 5, wherein: if there is no printer that is appropriate for the identified print job in the selection of an appropriate printer, the distributed print management server makes the print job wait temporarily, identifies the next print job that is different from the print job, and provides a distributed print start notification for the next print job to all of the plurality of printers.

Thus, the inconvenience of inhibiting the next print job from printing until the current job is handled can be avoided even if no printer that is appropriate for the current job is found. Accordingly, printing can be performed efficiently without a backlog of print jobs, without having to constantly monitoring the capabilities and status information of the printers.

Aspect 7 provides the distributed printing system according to any of aspects 1 to 6, wherein, the print job holding portion is a print queue holding the print jobs in the order in which the print jobs are received.

Thus, the distributed print management server can divide the print data into a plurality of print jobs in the order in which it received the print data and assign them to optimal printers. Accordingly, equitable and efficient distributed printing can be achieved.

Aspect 8 provides the distributed printing system according to any of aspects 1 to 7, wherein the print instructing device comprises: an input-output interface that communicably connects to the distributed print management server; a print data generating unit that generates print data from data to be printed and print settings that indicate printing mode of the data to be printed; a print request issuing unit that sends a print request to the distributed print management server through the input-output interface; and a print status display unit that receives a notification from the distributed print management server and displays a print status.

Thus, the print instructing device can reliably send distributed printing requested by the user to the distributed print management server. In addition, the user can readily know the status of the distributed printing he or she requested.

Aspect 9 provides the distributed printing system according to any of aspects 1 to 8, wherein the distributed print management server comprises: an input-output interface that communicably connects to the print instructing device and each of the printers; a print request receiving unit that receives a print request containing print data and print settings from the print instructing device; a print data dividing unit that divides the received print data into a plurality of print jobs for distributed printing; a print job holding portion managing unit that holds and manages the print jobs generated by dividing the print data and the correspondences of the status between the print jobs and the print data; and a distributed printing control unit that controls distributed printing interaction between the print job holding portion management unit and the printers.

Thus, the distributed print management server can divide print data into a plurality of print jobs and manage them according to a distributed printing request from the print instructing device and assign a print job most appropriate for a responding printer according to the printing capabilities and status of the printer.

Aspect 10 provides the distributed printing system according to aspect 9, wherein the distributed printing control unit comprises: a print starting module that issues a print start notification to the plurality of printers and receives and stores printing capability information of printers that has issued a print job acquisition request; a print job acquisition request receiving module that receives the print job acquisition request from the printers along with the status information of the printers and selects an optimal printer on the basis of the status information and the printing capability information to sends print data; and a print result receiving module that receives the result of print job execution from the printer.

Thus, the distributed print control unit of the distributed print management server can readily select a printer available for printing and send print data to it without having to constantly monitor the printing capabilities and status of the printers and obtain the result of the print job from the selected printer without fail and indicate it to a user.

Aspect 11 provides a distributed printing system comprising a print instructing device that generates print data and issues a distributed print request, a distributed print management server that divides the print data into a plurality of print jobs according to the distributed print request and stores the print jobs in a print queue, and a plurality of printers that acquire a print job from the distributed print management server and performs printing, wherein: each time the distributed print management server obtains a print job from the print queue, the distributed print management server provides distributed print start notification to all of the printers, selects printers available for printing from among printers that have issued a print job acquisition request, selects a printer that is appropriate for the print job from among the selected printers on the basis of printing capabilities and the status information of the printers, and assigns the print job to the printer.

This configuration allows the distributed print management server to select an optimum printer without having to constantly monitor the capabilities and status of each printer. Furthermore, distributed printing can properly be scheduled without a backlog of print jobs in the print queue because the printer is selected on the basis of not only the printing capabilities information but also the status information such as the number of remaining paper sheets and ink level of the printers. Consequently, distributed printing of a large quantity of documents can efficiently be performed even if printers installed vary in terms of printing capabilities and status.

Aspect 12 provides a distributed printing system comprising a print instructing device that generates print data and issues a distributed print request, a distributed print management server that divides the print data into a plurality of print jobs according to the distributed print request and stores the print jobs in a print queue, and a plurality of printers that acquire a print job from the distributed print management server and performs printing, wherein: each time the distributed print management server obtains a print job from the print queue, the distributed print management server provides distributed print start notification to all of the printers, selects printers available for printing from among printers that have issued a print job acquisition request, selects a printer that completes the print job in the shortest time from warm-up from among the selected printers, on the basis of printing capabilities and the status information of the printer, and assigns the print job to the printer.

This configuration provides the effect that a large amount of print data can be printed in a short time, in addition to the effects of aspect 11.

Aspect 13 provides the distributed printing system according to aspect 11 wherein, if there is no printer that is appropriate for a obtained print job, the print job is made wait temporarily, the next print job is obtained from the print queue, the distributed print start notification is provided to all of printers once again, printers that are available for printing are selected from among printers that have issued a print job acquisition, a printer that is appropriate for the print job is selected from the selected printers on the basis of printing capabilities and the status information of the printers, and the print job is assigned to the printer.

Accordingly, the distributed print management server allows printing to be performed efficiently without a backlog of print jobs in the print queue, without having to constantly monitoring the capabilities and status information of the printers.

Aspect 14 provides the distributed printing system, wherein the print instructing device comprises: an input-output interface that communicably connects to the distributed print management server; a print data generating unit that generates print data from data to be printed and print settings that indicate printing mode of the data; a print request issuing unit that sends a print request to the distributed print management server through the input-output interface; and a print status display unit that receives a notification from the distributed print management server and presents a print status to a user.

Thus, distributed printing requested by the user can be reliably sent to the distributed print management server. In addition, the user can readily know the status of the distributed printing he or she requested.

Aspect 15 provides the distributed printing system, wherein the distributed print management server comprises: an input-output interface that communicably connects to the print instructing device and each of the plurality of printers; a print request receiving unit that receives a print request containing print data and print settings from the print instructing device; a print data dividing unit that divides the received print data into a plurality of print jobs for distributed printing; a print queue managing unit that holds and manages the print jobs generated by dividing the print data and the correspondences of the status between the print jobs and the print data; and a distributed printing control unit that controls distributed printing interaction between the print queue management unit and the printers.

Thus, print data can be divided into a plurality of print jobs and managed according to a distributed printing request from the print instructing device, and a print job most appropriate for a responding printer can be assigned according to the printing capabilities and status of the printer.

Aspect 16 provides the distributed printing system, wherein the distributed printing control unit comprises: a print starting processing unit that issues a print start notification to the plurality of printers and receives and stores printing capability information of printers that has issued a print job acquisition request; a print job acquisition request receiving unit that receives the print job acquisition request from the printers along with the status information of the printers and selects an optimal printer on the basis of the status information and the printing capability information to send print data; and a print result receiving unit that receives the result of print job execution from the printer.

Thus, a printer available for printing can readily be selected and print data can be sent to it without having to constantly monitor the printing capabilities and status of the printers. In addition, the result of the print job can be obtained from the selected printer without fail and indicated to the user.

Aspect 17 provides the distributed printing system, wherein the printers comprise: a print control unit that provides a print job acquisition request to the distributed print management server along with the printing capability information and status information of the printers if the printers are idle when the printers receive a print start notification from the distributed print management server, and controls general aspects of printing; an image processing unit that processes print data received from the distributed print management server to generate printable data; a printing unit that prints the printable data generated by the image processing unit; and an input-output interface that communicably connects the print control unit, the image processing unit, and the printing unit with the distributed print management server.

Thus, the printers can actively obtains a print job and therefore the need for the management of the capabilities and status of all printers by the distributed print management server can be eliminated. In addition, printing of an assigned print job can be ensured.

Aspect 18 provides a distributed printing method that divides print data into a plurality of print jobs and assigns one of a plurality of printers to each of the plurality of print jobs for performing distributed printing, the method comprising: when each print job is identified, providing a distributed print start notification to all or some of the printers; selecting a printer that is appropriate for the each print job from among printers that have issued a print job acquisition request, on the basis of printing capabilities and the status information of the printers; and assigning the each print job to the selected printer.

Like the distributed printing system according to aspect 1, this distributed printing method allows distributed printing to be properly scheduled without a backlog of print jobs in the print job holding portion, without having to constantly monitor the printing capabilities and status of the printers. Consequently, efficient distributed printing of a large amount of print data can be performed even if printers installed vary in. printing capabilities and status.

Aspect 19 provides a distributed printing method that divides print data into a plurality of print jobs and assigns one of a plurality of printers to each of the plurality of print jobs for performing distributed printing, the method comprising: when each print job is identified, providing a distributed print start notification to all or some of the printers; selecting a printer that completes the print job in the shortest time from warm-up from among printers that have issued a print job acquisition request, on the basis of printing capabilities and the status information of the printers; and assigning the print job to the selected printer.

This distributed printing method provides the effect that a large amount of print data can be printed in a short time, in addition to the effects of aspect 9.

Aspect 20 provides a distributed printing method that divides print data into a plurality of print jobs and assigns one of a plurality of printers to each of the plurality of print jobs for performing distributed printing, the method comprising: when each print job is identified, providing a distributed print start notification to all or some of the printers; selecting a printer that completes the print job in the shortest time from print data reception from among printers that have issued a print job acquisition request, on the basis of printing capabilities and the status information of the printers; and assigning the print job to the selected printer.

This distributed printing method provides the effect that a large amount of print data can be printed in a short time, in addition to the effects of aspect 9.

Aspect 21 provides a distributed printing method that divides print data into a plurality of print jobs and assigns one of a plurality of printers to each of the plurality of print jobs for performing distributed printing, the method comprising: when each print job is identified, selecting printers that are available for printing from among printers that have issued a print job acquisition request; and selecting a printer that is appropriate for the print job from among the selected printers on the basis of printing capabilities and the status information of the printers; and assigning the print job to the printer.

Thus, the need for the distributed print management server to provide notifications to the printers is eliminated. Consequently, additional facilities and sending procedures are eliminated and the configuration of the system is simplified. Also, the distributed print management server can be provided outside a firewall and yet high security can be ensured.

Aspect 22 provides the distributed printing method according to any of aspects 18 to 21, wherein, if there is no printer that is appropriate for the identified print job, the print job is made wait temporarily, the next print job that is different from the print mob is obtained, and a distributed print start notification is provided to all or some of the printers.

Thus, printing can be performed efficiently without a backlog of print jobs in the print job holding portion, without having to constantly monitoring the capabilities and status information of the printers.

Aspect 23 provides a distributed printing method that divides print data into a plurality of print jobs and assigns one of a plurality of printers to each of the plurality of print jobs for performing distributed printing, the method comprising: each time a print job is obtained, a distributed print start notification is provided to all of the printers, selecting printers available for printing from among printers that have issued a print job acquisition request; selecting a printer that is appropriate for the print job from among the selected printers, on the basis of printing capabilities and the status information of the selected printers; and assigning the print job to the printer.

This distributed printing method allows distributed printing to be properly scheduled without a backlog of print jobs in the print queue, without having to constantly monitor the printing capabilities and status of the printers. Consequently, efficient distributed printing of a large amount of print data can be performed even if printers installed vary in printing capabilities and status.

Aspect 24 provides a distributed printing method that divides print data into a plurality of print jobs and assigns one of a plurality of printers to each of the plurality of print jobs for performing distributed printing, the method comprising: each time a print job is obtained, a distributed print start notification is provided to all of the printers, selecting printers available for printing from among printers that have issued a print job acquisition request; selecting a printer that completes the print job in the shortest time from warm-up from among the selected printers, on the basis of printing capabilities and the status information of the selected printers; and assigning the print job to the printer.

This distributed printing method provides the effect that even a large amount of print data can be printed in a short time, in addition to the effects of aspect 23.

Aspect 25 provides the distributed printing method according to aspects 23 and 24 wherein, if there is no printer that is appropriate for a obtained print job, the print job is made wait temporarily, the next print job is obtained from the print queue, the distributed print start notification is provided to all of the printers once again, printers that are available for printing are selected from among printers that have issued a print job acquisition, a printer that is appropriate for the print job is selected from the selected printers on the basis of printing capabilities and the status information of the printers, and the print job is assigned to the printer.

Thus, printing can be performed efficiently without a backlog of print jobs in the print queue, without having to constantly monitoring the capabilities and status information of the printers.

Aspect 26 provides a distributed printing program used in a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the program causes a computer of each of the printers to receive a print start notification from the distributed print management server and, if the printer is available for printing, provide a print job acquisition request to the distributed print management server along with the printing capability information and status information of the printer; and the program causes a computer of the distributed print management server to: identify the print job to be printed from the print job holding portion; provide distributed print start notification to all or some of the plurality of printers; select from among printers that have issued a print job acquisition request a printer that is appropriate for the print job on the basis of printing capabilities and the status information of the printer; and assign the print job to the printer.

The program of aspect 26 can achieve the effect equivalent to that of aspect 1 as well as the effect that a general-purpose computer system such as a personal computer or a computer system contained in a printer can be used to provide its functions in software without modification. Accordingly, aspect 26 can be embodied economically and easily compared with a case where a special apparatus is used.

Aspect 27 provides a distributed printing program used in a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the program causes a computer of each of the printers to receive a print start notification from the distributed print management server and, if the printer is available for printing, provide a print job acquisition request to the distributed print management server along with the printing capability information and status information of the printer; and the program causes a computer of the distributed print management server to: provide distributed print start notification to all or some of the plurality of printers each time the distributed print management server obtains a print job from the print job holding portion; select from among printers that have issued a print job acquisition request a printer that completes the print job in the shortest time from warm-up, on the basis of printing capabilities and the status information of the printer; and assign the print job to the printer.

The program of aspect 27 can achieve the effect equivalent to that of aspect 3 and, like aspect 26, can achieve the effect that a general-purpose computer system such as a personal computer or a computer system contained in a printer can be used to provide its functions in software without modification. Accordingly, aspect 27 can be embodied economically and easily.

Aspect 28 provides a distributed printing program used in a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the program causes a computer of each of the printers to receive a print start notification from the distributed print management server and, if the printer is available for printing, provide a print job acquisition request to the distributed print management server along with the printing capability information and status information of the printer; and the program causes a computer of the distributed print management server to: provide distributed print start notification to all or some of the plurality of printers each time the distributed print management server obtains a print job from the print job holding portion; select from among printers that have issued a print job acquisition request a printer that completes the print job in the shortest time from print job reception, on the basis of printing capabilities and the status information of the printer; and assign the print job to the printer.

The program of aspect 28 can achieve the effect equivalent to that of aspect 4 and, like aspect 26, can achieve the effect that a general-purpose computer system such as a personal computer or a computer system contained in a printer can be used to provide its functions in software without modification. Accordingly, aspect 28 can be embodied economically and easily.

Aspect 29 provides a distributed printing program used in a distributed printing system comprising a print instruction device that issues a distributed print request based on print data, a distributed print management server that divides the print data into a plurality of print jobs according to the distributed print request and stores the print jobs in a print job holding portion, and a plurality of printers that acquire the print jobs from the distributed print management server and performs printing, wherein: the program causes a computer of each of the printers to provide a print job acquisition request to the distributed print management server along with the. printing capability information and status information of the printer if the printer is available for printing; and the program causes a computer of the distributed print management server to: select printers that are available for printing from among printers that have issued the print job acquisition request beforehand each time the distributed print management server obtains a print job from the print job holding portion; select a printer that is appropriate for the print job from among the selected printers on the basis of printing capabilities and the status information of the printers; and assign the print job to the printer.

The program of aspect 29 can achieve the effect equivalent to that of aspect 3 and, like aspects 26 and 27, can achieve the effect that a general-purpose computer system such as a personal computer or a computer system contained in a printer can be used to provide its functions in software without modification. Accordingly, aspect 29 can be embodied economically and easily.

Aspect 30 provides a distributed printing program for causing a computer to function as a print instructing section that generates print data and issues a distributed print request; a distributed print managing section that divides the print data into a plurality of print jobs according to the distributed print request and stores the print jobs in a print queue; and a plurality of print controlling section that obtains a print job from the distributed print managing section and causing printing, wherein: the distributed print managing section further includes the function of, when the distributed print managing section receives the distributed print request, providing a distributed print start notification to all of the print controlling section, selecting a print controlling section that is appropriate for printing the print job from among print controlling section that have issued a print job acquisition request, and sending the job to the print controlling section.

Thus, the distributed printing system according to aspect 1 can be implemented by using a general-purpose computer without modification and without providing special devices. Accordingly, the cost required for implementing the system can be significantly reduced.

Aspect 31 provides a distributed printing program for causing a computer to function as a print instructing section that generates print data and issues a distributed print request; a distributed print managing section that divides the print data into a plurality of print jobs according to the distributed print request and stores the print jobs in a print queue; and a plurality of print controlling section that obtains a print job from the distributed print managing section and causing printing, wherein: the distributed print managing section further includes the function of, when the distributed print managing section receives the distributed print request, providing a distributed print start notification to all of the print controlling section, selecting a print controlling section that completes the print job in the shortest time from warm-up from among print controlling section that have issued a print job acquisition request, and sending the job to the print controlling section.

Therefore, aspect 31 has the effect that a large amount of data can be printed in a short time, in addition to the effects of aspect 30.

Aspect 32 provides a printer connected to a distributed print management server dividing print data into plurality of print jobs and storing the print jobs through a network, wherein the printer receives a print start notification from the distributed print management server and, if the printer is available for printing, provides a print job acquisition request for the print job to the distributed print management server along with the printing capability information and status information of the printer.

Like aspect 1, this configuration allows the distributed print management server to select an optimum printer without having to constantly monitor the capabilities and status of each printer. Furthermore, distributed printing can properly be scheduled without a backlog of print jobs because the printer is selected on the basis of not only the printing capabilities information but also the status information such as the number of remaining paper sheets and ink level of the printers.

Consequently, distributed printing of a large quantity of documents can efficiently be performed even if printers installed vary in terms of printing capabilities and status.

Aspect 33 provides a printer management server that is connected to a plurality of printers through a network, divides print data into a plurality of print jobs and stores the print jobs, wherein the printer management server identifies one of the print jobs to be printed, provides the distributed print start notification to all or some of the plurality of printers, selects from among printers that have issued an acquisition request for the print job a printer that is appropriate for the print job on the basis of printing capabilities and status information of the printers, and assigns the print job to the printer.

Like aspect 1, this configuration allows the distributed print management server to select an optimum printer without having to constantly monitor the capabilities and status of each printer. Furthermore, distributed printing can properly be scheduled without a backlog of print jobs because the printer is selected on the basis of not only the printing capabilities information but also the status information of the printers.

Consequently, distributed printing of a large quantity of documents can efficiently be performed even if printers installed vary in terms of printing capabilities and status.

### BRIEF DESCRIPTION OF THE DRAWINGS

FIG. 1 is a block diagram of a distributed print system according to one embodiment of the present invention;

FIG. 2 is a block diagram showing a basic configuration of a print instructing device;

FIG. 3 is a block diagram showing a basic configuration of a distributed print management server;

FIG. 4 is a block diagram showing a basic configuration of a printer;

FIG. 5 shows a hardware configuration for implementing functions by using software;

FIG. 6 shows a structure of a print request issued from the print instructing device;

FIG. 7 shows an example of a distributed print request;

FIGS. 8A to 8D show examples of information about printing capabilities and status of printers;

FIG. 9 shows exemplary print jobs stored in a print queue;

FIG. 10 is a flowchart of an exemplary printing process flow; and

FIG. 11 is a flowchart of an exemplary printing process flow.

### DETAILED DESCRIPTION OF THE PREFERRED EMBODIMENTS

The best mode for carrying out the present invention will be described below with reference to the accompanying drawings.

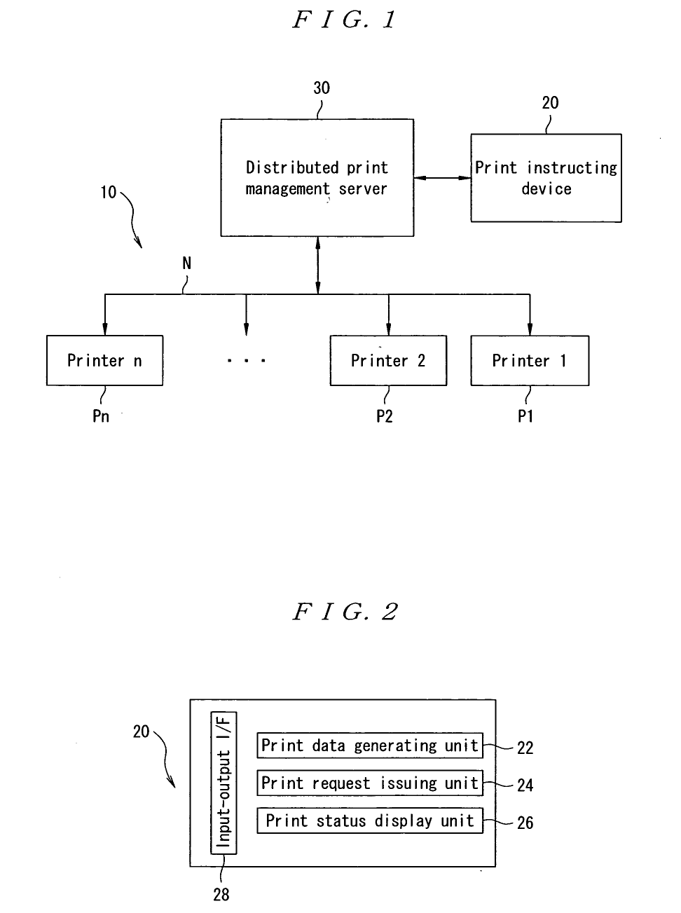

FIG. 1 shows a distributed printing system 10 according to an embodiment of the present invention.

As shown, the distributed printing system 10 comprises a print instructing device 20 that generate print data and issues a distributed print request, a distributed print management server 30 that transfers a print job in response to a distributed print request, and a number of printers (P1, P2, . . . , Pn) that obtain a print job from the distributed print management server 30 and print data, which are interconnected through a network N such as a LAN or the Internet in such a way that they can bidirectionally communicate with one another. The print instructing device 20, distributed print management server 30, and printers P will be detailed below.

The print instructing device 20 is a device such as a client personal computer and comprises a print data generating unit 22, a print request issuing unit 24, and a print status display unit 26 as shown in FIG. 2. These components are connected to the distributed print management server 30 through an input-output interface 28.

The print data generating unit 22 generates data such as text and images to be printed and print settings such as a specific printing mode. The print request issuing unit 24 issues and sends a print request to the distributed print management server 30 through the input-output interface 28. The print status display unit 26 receives a report such as a pint status, print error, and a print result from the distributed print management server 30 and presents it on a monitor to a user.

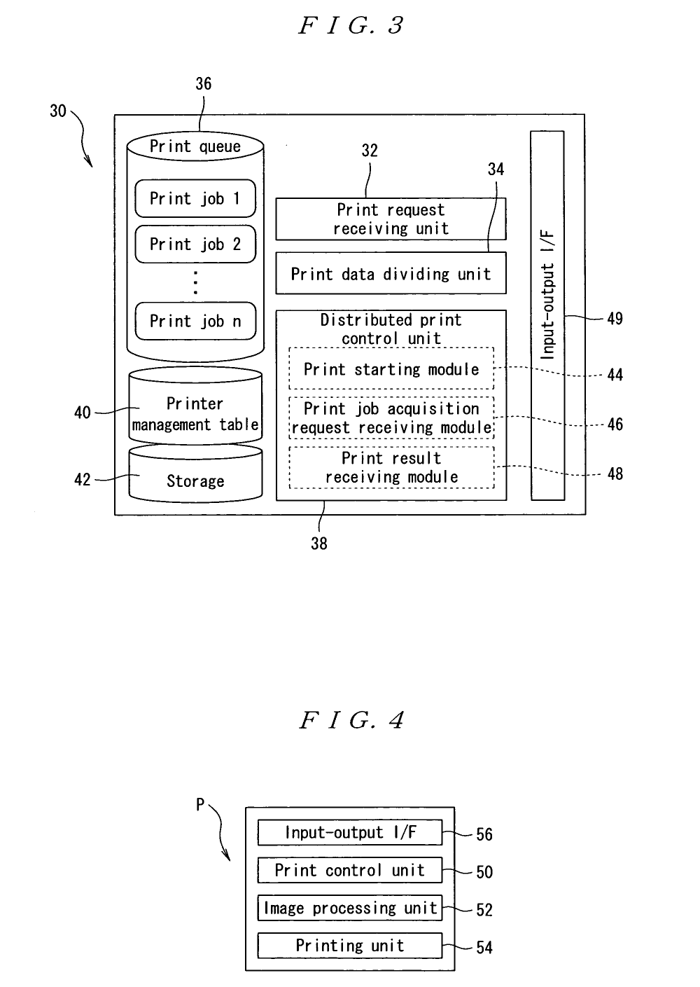

The distributed print management server 30 comprises a print request receiving unit 32, a print data dividing unit 34, a print job storage unit 36 storing print jobs in print queue form, a distributed print control unit 38, a printer management table 40, and a storage unit 42, as shown in FIG. 3. These components are connected to the print instructing device 20 and the printers P1, P2, . . . , Pn through the input-output interface 49.

The print request receiving unit 32 receives a print request from the print instructing device 20. A print request contains general print settings (e.g., print data and the number of print copies) as well as settings relating to distributed printing.

The print data dividing unit 34 divides print data for distributed printing if a print request received from the print instructing device 20 is a distributed print request. Print data is divided into units of pages or copies and the units of pages or copies are stored in one print queue as a number of print jobs.

The print job storage unit 36 holds a correspondence between print data divided for distributed printing and the status of the print job. The status of the print job put into the print queue is set waiting.

The printer management table 40 manages the print capabilities and status information of printers P. The storage unit 42 stores a print queue, print data, the printer management table 40, and other data.

The distributed print control unit 38 includes a print starting module 44, a print job acquisition request receiving module 46, and a print result receiving module 48.

The print starting module 44 issues a print start notification to all printers, receives information about printing capabilities such as printing speed and color/monochrome print capability as a response to the notification and stores the information about the print capabilities in the printer management table 40. This information is uses to select a printer on which print data is to be printed.

The print job acquisition request receiving module 46 receives a print job acquisition request from a printer. A print job acquisition request contains status information such as the status of a printer, the number of paper sheets remaining in the printer, the number of pages (equivalent to ink/toner level) that can be printed on the printer.

The print job acquisition request receiving module 46 selects the most appropriate printer on the basis of the status information and print capabilities. Print data is sent to the selected printer for printing.

The print result receiving module 48 receives the result of an executed print job from a printer. If printing is successful, the print job is removed from the print queue and the success is stored in the storage unit 42. If printing fails, error information is stored and error handling specified by the print instructing device 20 is performed.

When the print queue becomes empty, print completion is indicated to the printer P and then the result of distributed printing which is stored in the storage unit 42 is reported to the print instructing device. Then the distributed printing is ended.

Each of the printers P1, P2, . . . , Pn comprises a print control unit 50, an image processing unit 52, and a printing unit 54 as shown in FIG. 4. These units are communicably connected to the distributed print management server 30 through the input-output interface 56.

The print control unit 50 controls all aspects of printing. In particular, the print control unit 50 (1): receives a print start notification; (2) returns information about print capabilities such as the printing speed and color/monochrome printing capability of the printer as a response to a print start notification; (3) issues a print job acquisition request to the distribution print management server 30 along with status information when the printing function is idle (in a state where a print job can be accepted. However, the warm-up does not have to be finished.) or when a print job is completed; (4) if successfully acquires a print job, receives print data and prints the job; (5) if fails to acquire a print job, waits until the next print start notification is sent (if it receives a print wait notification) and, after receiving a print start notification, issues a print job acquisition request again to the distributed print management server 30; (6) if printing of a print job is successfully completed, sends a print completion notification to the distributed print management server 30; (7) if an error occurs during processing a print job, provides error information to the distributed print management server 30; and performs other processes.

The image processing unit 52 processes print data to generate printable data. The printing unit 54 prints printable data generated by the image processing unit 52.

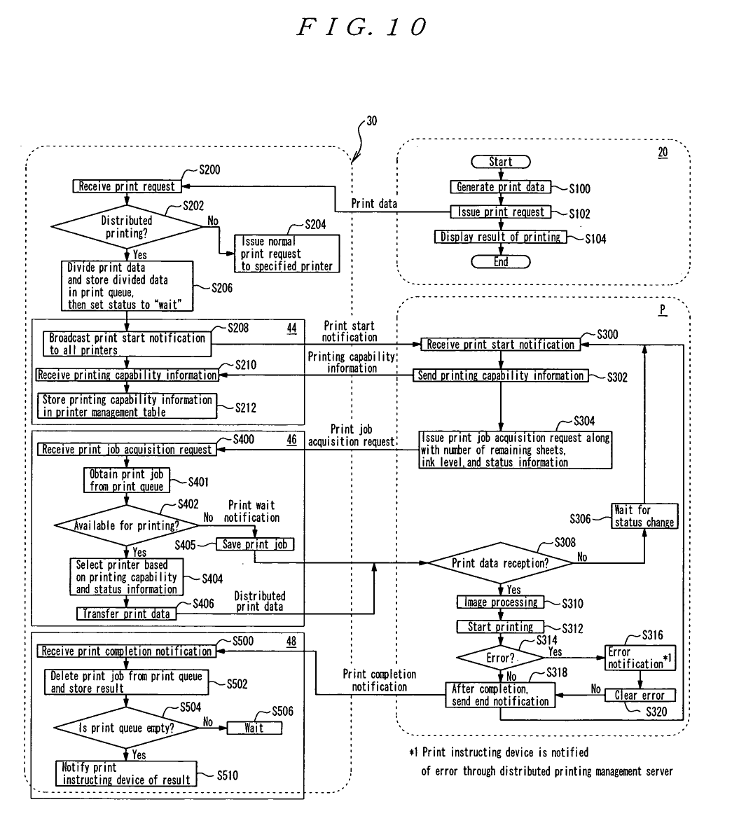

The functions of the print data generating unit 22, print request issuing unit 24, and print status display unit 26 of the print instructing device 20, the distributed print control unit 38 and print data dividing unit 34 of the distributed print management server 30, and the print control unit 50 and image processing unit 52 of a printer P are specifically implemented by a computer system consisting of hardware such as a central processing unit and main memory and software (a processing program) as shown in FIG. 10.

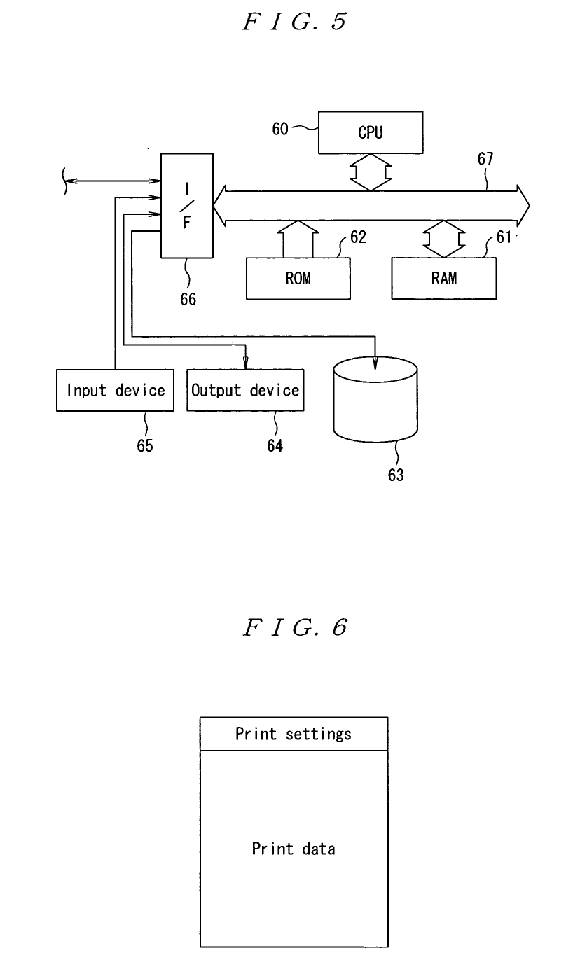

In particular, the computer system for implementing the functions comprises a CPU (Central Processing Unit) 60 providing controls and processing, a RAM (Random Access Memory) 61 used as a main storage, a ROM (Read Only Memory) 62, a secondary storage device 63, which may be a HDD (Hard Disk Drive) or semiconductor memory, an output device 64, which may be a monitor (LCD (Liquid Crystal Display) or a CRT (Cathode Ray Tube) display), an input device 65, which may be a keyboard and a mouse, a network N, and an input-output interface (I/F) 66, which are interconnected by internal and external buses 67, such as a processor bus, memory bus, system bus, and an input-output bus, which may be a PCI (Peripheral Component Interconnect) bus and an ISA (Industrial Standard Architecture) bus, as shown in FIG. 5.

Dedicated control programs and data provided via a storage medium, such as a CD-ROM, DVD-ROM, floppy disks for storing control programs, or through the communication network N are installed in a storage device such as the secondary storage device 63 and loaded into the main storage 61 as required. The CPU 60 uses appropriate resources to perform predetermined control and processing according to programs loaded in the main storage 61. The results of the processing (processed data) is provided to the output device 64 through the buses 67. The data is displayed on the output device 64, stored and/or saved (updates data) in a database provided in the secondary storage 63, as appropriate.

The storage medium for storing the control programs may be a computer-readable storage medium such as an MD (Mini-Disk), an optically readable storage medium such as an LD (Laser Disc), or a magneto-optical storage medium such as an MO (Magneto-Optic) disc, as well as a CD-ROM, DVD-ROM, and floppy disks as mentioned above.

A printing process flow according to the present invention will be detailed below.

As shown in a process flow in FIG. 10, the print instructing device 20, which is operated by a user, first uses application software such as word processing software or an editor to generate print data, which may be text or images at step S100, then generates a print request consisting of the print data with print settings added to it as shown in FIG. 6, and provides it to the distributed print management server 30 (step S102).

A print request may include print settings such as the identification of a destination printer, the number of print copies, indication as to whether double-sided printing is used and whether distributed printing is used, and an action (reprinting all pages, reprinting the page at which the error occurred and the subsequent pages, printing the remaining pages without respect to the error, or aborting printing) to be taken if an error occurs during distributed printing.

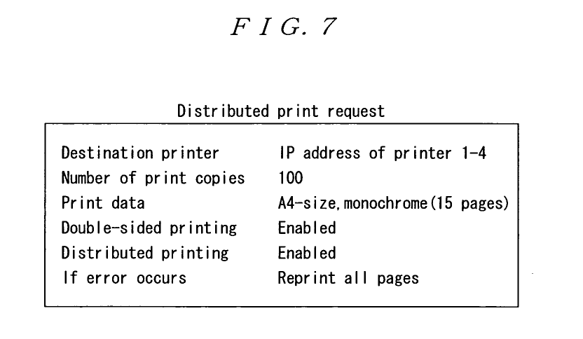

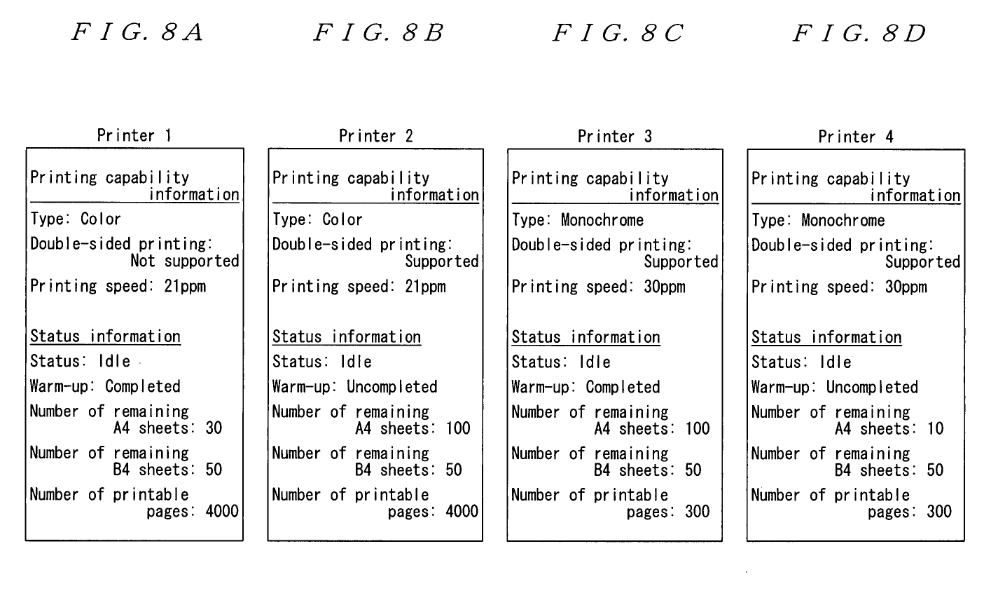

In the present embodiment, a distributed print request as shown in FIG. 7 is issued. Printers 1-4 having properties as shown in FIGS. 8A to 8D are provided in the system of this example. As shown in FIG. 7, this distributed print request specifies: the IP address of printers 1-4 as destination printers, “100” as the number of print copies, “A4-size monochrome (15 pages)” as print data, double-sided printing “enabled,” and “reprint all pages” as an action to be taken if an error occurs.

The printers 1-4 provides information about their printing capabilities and status to the distributed print management server 30, as shown in FIGS. 8(a) to 8(d).

Printer 1 indicates printing capability information, “Type: Color, Double-sided printing: Not supported, Printing speed: 21 ppm,” and status information, “Status: Idle, Warm-up: Completed, Number of remaining A4 sheets: 30, Number of remaining B4 sheets: 50, Printable pages: 4000.” Printer 2 indicates that it supports double-sided printing, and has not yet warmed up, and is loaded with 100 A4 paper sheets, which number is far more than that in printer 1. Printer 3 supports double-sided printing and can print at a speed of as high as 30 ppm, is a monochrome type printer, and can print 300 pages, which is far less than that of printer 1. Printer 4 supports double-sided printing and provides a printing speed of 30 ppm like printer 3, but has not yet warmed up and has 10 remaining A4 sheets, which is far less than that in printer 1.

The distributed print management server 30 receives the print request (print data) from the print instructing device 20 at step S200, then proceeds to step S202, where the print request is examined to make a determination as to whether the it is a distributed print request. If it is not a distributed print request (No), the process proceeds to step S204, where the print request is provided to the printer specified in the print settings.

On the other hand, if the print request received is a distributed print request (Yes), the distributed print management server 30 divides the print data into a number of print jobs and stores the print jobs in a print queue (step S206). Then the print starting module 44 in the distributed print management server 30 broadcasts a print start notification to all printers P (step S208).

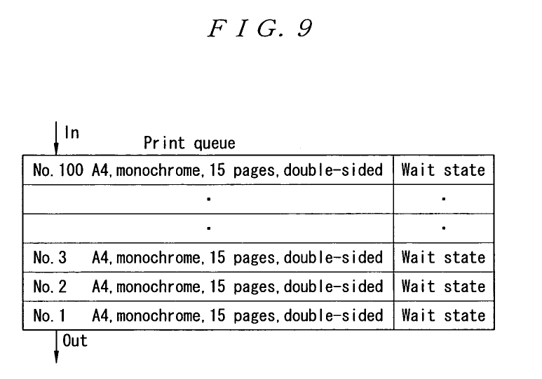

In the present embodiment, the distributed print management server 30 divides the print data into 100 print jobs (No. 1-No. 100), which number is the number of print copies specified in the distributed print request, and stores them in the print queue, as shown in FIG. 9.

Then all printers P1-P4 receive the first print start notification from the distributed print management server 30. If a printer P is available for printing requested by the distributed print request (if it is idle), the printer P adds its print capability information (type, double-printing enabled or disabled, printing speed, etc.) and the current status information (status, warm-up completed or uncompleted, the number of remaining sheets, the number of printable pages, toner level, ink level, etc.) to the request to generate a print job acquisition request and sends it to the distributed print management server 30 (step S300).

In the present embodiment, the status of all printers P1-P4 is “idle” as shown in FIGS. 8(a) to 8(d). Accordingly, all printers P1-P4 issues a print job acquisition request to the distributed print management server 30.

The print capability information is also sent to the print starting module 44 and the print starting module 44 records the print capability information of printers P1-P4 in the printer management table 40 (steps S210 and S212).

The print job acquisition request receiving module 46 in the distributed print management server 30 receives the print job acquisition request from the printer P (step S400), obtains the first job from the print queue (step S401), and determines whether the printer P is available for printing (step S402). From among printers that are found to be available (Yes) for printing, a printer P that is most appropriate for the job is selected on the basis of the printing capability and status information. For example, if the print job requires a high printing speed, the printer P that can complete the print job in the shortest time, including a warm-up time if not warmed-up, is selected (step S404).

For example, if a print job requires a high printing speed and print job acquisition requests are received from printer 1 and printer 3 shown in FIGS. 8(a) and 8(c) at the same time, both printers are idle and available for printing. Therefore, the printing capabilities of printers 1 and 3 are considered and the most appropriate one is selected.

Because it is found that the printing capabilities of the printers, the printing speed of printer 1 is 21 ppm and that of printer 3 is 30 ppm and both printers have been warmed up, printer 3 that can complete the print job in the shortest time after warm-up is selected in this case. If print job acquisition requests are received from printer 1 and printer 2 in FIGS. 8(a) and 8(b) at the same time under the same conditions, the print job acquisition request from printer 1 is given precedence because printer 2 has not yet warmed up and therefore requires more time to start printing although printer 1 and printer 2 provide the same printing speed.

If print job acquisition requests are received from printer 1 and printer 4 in FIGS. 8(a) and 8(d) at the same time, the print job acquisition request from printer 1 is given precedence because, although printer 4 provides a higher printing speed, printer 4 has not yet warmed up and is not ready to start printing. In particular, if the warm-up time, which should be included in the time required for printing, is 20 seconds, the time required for printer 1 to complete printing is approximately 7 seconds shorter than printer 4, as shown below.

Printer 1: 1/21ppm×60 seconds×15 pages=42.8 seconds

Printer 4: 1/30ppm×60 seconds×15 pages+20 seconds=50.0

After the most appropriate printer P is selected in this way (step S404), the print data of the print job is sent to the selected printer P (step S406) and a print wait notification is sent to the other printers P. On the other hand, if a printer available for printing is not found at step S402 (the determination is No), the print job is placed in the print queue (step S405) and a print wait notification is provided to the unselected printers.

For example, if print job No. 1, which is the first job to be handled, specifies A4 size paper, monochrome printing as shown in FIG. 9, and double-sided 15 pages and the print job acquisition request from printer 2 shown in FIG. 8B is selected, print data is sent to printer 2 because the printing capability of printer 2 satisfies all of the requirements of paper size, the number of sheets, double-printing function, and the number of printable pages.

In contrast, if the print job acquisition request from printer 4 shown in FIG. 8D is selected, print job No. 1 cannot be handled because the number of remaining A4 sheets in printer 4 is only 10. Also, if the print job acquisition request from printer 1 shown in FIG. 8A is selected, print job No. 1 cannot be printed because printer 1 does not support double-sided printing.

Therefore, the distributed printing request in this case is performed by printer 2 and printer 3, and in addition, printer 4 after it is loaded with a sufficient number of paper sheets.

If it is determined at step S402 that a printer P is unavailable for the printing (the determination is No), a print wait is provided to the printer p to keep the printer P waiting until the next print job occurs (steps S306 and S308). The destination to which print data is sent at step S406 can be identified by the IP address of the selected printer P.

A printer P that issued a print job acquisition request determines whether it has received print data (step S308) and if the determination is Yes, the printer performs image processing of the print data and starts printing (steps S310 and S312).

The printing is constantly monitored for errors (step S314). If the printing is successfully complete without errors (determination at step S314 is No), (the print result receiving module 48) the distributed print management sever 30 is notified of the completion of printing (step S318).

On the other hand, if an error occurs during printing (the determination at step S314 is Yes), the printer P notifies the print instructing device 20 of the error through the distributed print management server 30 (steps S316 and S104). Then an action for clearing the error is performed (step S320). If the action clears the error and the printing is completed, the printer notifies the distributed print management server 30 of the completion of printing (steps S318 and S104). Then the process proceeds to step S300, where the printer waits for a print start notification.

The distributed print management server 30 (print result receiving module 48) receives the result of the print job from the printer P to which it has issued the distributed print request. If the print job is successfully completed (step S500), the print job is removed from the print queue and the result is stored in the storage unit 42.

Notifications of print job completion are made one by one in this way, a determination is made as to whether the print queue becomes empty (step S504). If a job remains in the print queue (the determination is No), the distributed print management server 30 waits until the next print completion notification (step S506). If it is determined that the print queue become empty (the determination is Yes), the result is reported to the print instructing device 20 (step S104) the process ends (step S510).

In the present embodiment, a distributed print request is broadcasted to all printers, the most appropriate printer is selected from among printers returning a response on the basis of information about. the printing capabilities and status of the printers, and a print job is assigned to the selected printer, as described above. Thus, the most appropriate printer can be selected without having to constantly monitor the capabilities and status of each individual printer.

Furthermore, because not only the printing capabilities but also the status information such as the number of remaining paper sheets and ink level of the printers are used as criteria to select a printer, distributed printing jobs can be scheduled smoothly without keeping them waiting in the print queue.

Consequently, distributed printing of a large amount of print data can efficiently be performed even if printers installed vary in terms of printing capabilities and status.

While the distributed print management server 30 issues print start and end notifications to the printers P to indicates the start and end of distributed printing in the present embodiment, the print start and end notifications can be omitted in a configuration in which printers P that are activated and idle try constantly to acquire a print job.

In that configuration, there is no opportunity of obtaining information about the printing capabilities (such as support for color/monochrome printing and double-sided printing) of the printers. However, this can be addressed by including the information about the printing capabilities in the status information of the printers that is sent when the print job acquisition is required.

Print data and print jobs generated by dividing print data does not necessarily have to be stored in the print queue. They may be stored in a storage unit 42. In that case, the print queue is used only for managing the correspondence between the print jobs and the print data.

The distributed print management server 30 may be provided in a print server or a printer P, as well as a server computer on the network.

While a printer is selected that can print in the shortest time in the present embodiment described above, a printer may be selected so that the printers owned can be kept in as good a condition as possible. For example, in order to prevent some of printers from being heavily used, a printer may be selected on the basis of the total number of pages printed on the printers since they have been installed, or on the basis of the number or frequency of failures of the printers and the importance level of printing. Alternatively, a printer that has not been used for a long time is selected first on the basis of the frequency of use of the printers. Furthermore, a printer may be selected on the basis of the consumption level of consumables such as the toner or ink level in order to prevent unexpected toner/ink out from being encountered during printing.

A protocol used in communication among the print instructing device 20, distributed print management server 30, and printers P is not limited to specific one. If the communication is performed over the Internet, TCP/IP, which is a standard protocol used on the Internet, will inevitably be used. In a homogeneous LAN from a certain vendor, a certain protocol such as AppleTalk/EtherTalk®, NetBEUI/NetBIOS®, or SPX/IPX® can be used.

For example, if TCP/IP is used, typically the following protocols may be used: TCP (Transmission Control Protocol), which establishes connection between a device management serve 12 and a device 10 to ensure reliable communication, UDP (User Datagram Protocol) UDP, which is a connectionless protocol for providing efficient communication, IP (Internet Protocol) for transmitting packets to a given destination through a channel among a large number of channels, Telnet (Telecommunication Network), which is a protocol for remotely controlling a terminal from another terminal through a network, FTP (File Transfer Protocol), which uses Telnet to transfer files, NFS (Network File System), ARP and RARP (Address Resolution Protocol, Reverse ARP), SLIP and PPP (Serial Line Protocol, Point to Point Protocol), RIP and OSPF (Routing Information Protocol, Open Shortest Path First), RSVP (Resource Reservation Protocol), IPsec (IP security Protocol), IGMP (Internet Group Management Protocol), NTP (Network Time Protocol), which provide transparent file access from a computer to another computer.

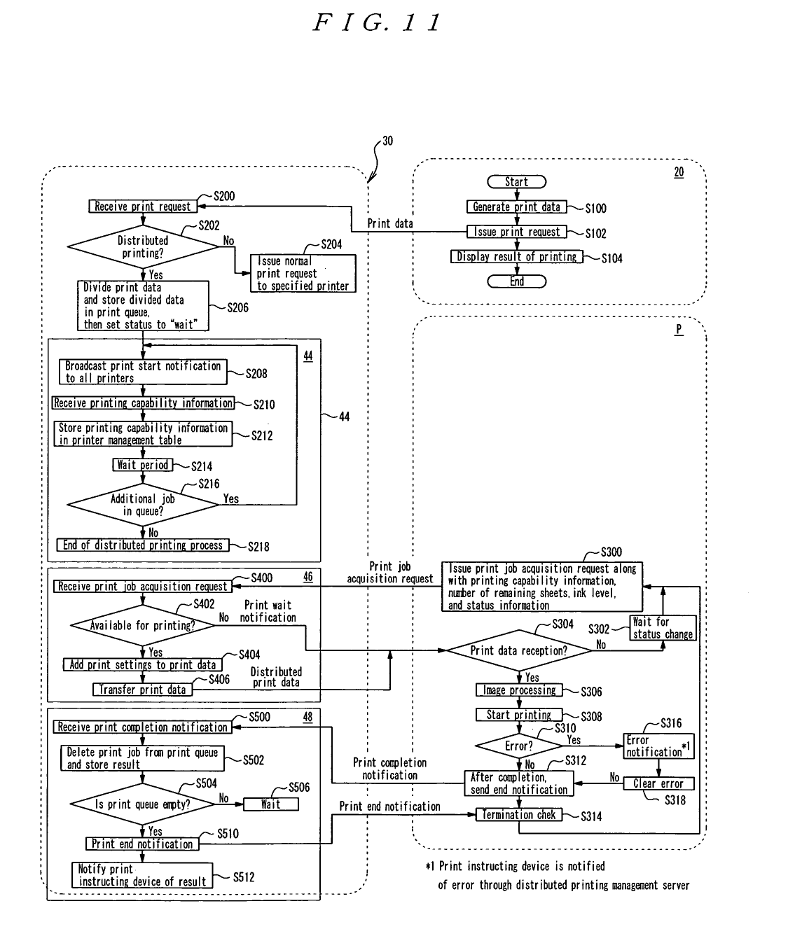

In alternative embodiment, rather than sending a print start notification from the distributed print management server 30 every time a print job is performed, a printer P that becomes ready to print may send a print job acquisition request to the distributed print management server 30 on one-way basis once a print start notification has been provided from the distributed print management server 30, as shown in FIG. 11.

When the print starting module 44 of the distributed print management server 30 broadcasts a print start notification to all printers (step S208) as described in the embodiment described above, a printer P, among printers having received the notification, that cannot accept the print request because it is performing another print request or for some other reason cannot issue a print job request and idly waits until the next print start notification is broadcasted. This is waste of time.

Therefore, in the alternative embodiment, a printer P that becomes ready to print autonomously issues a print job acquisition request to the distributed print management server 30 regardless of whether or not a print start notification is broadcasted from the distributed print management server 30 as shown in FIG. 11.

Among printers P that have not responded to a print start notification from the print starting module 44 of the distributed print management server 30, a printer that subsequently becomes ready to print sends a print job acquisition request along with information about the printing capabilities and status of the printer such as the number of remaining paper sheets as shown at step S300 in FIG. 11. The print job acquisition request receiving module 46 of the distributed print management server 30 receives it and determines whether or not any of print jobs in the print queue can be printed on that printer P (step S404).

If it is determined that there is no print job that can be printed on that printer P (the determination is No), then a print wait notification is provided to the printer P. Otherwise (if the determination is Yes), then print settings set for the print job are added to the print data and the print data is transferred to the printer P (steps S404 and S406).

In this way, the printer P that has issued the print job acquisition request waits for a response from the distributed print management server 30 (step S304). If the printer P determines that it has not received print data after a predetermined time (the determination is No), or it receives a print wait notification, the printer P returns from the status change wait state (step S302) to step S300 and re-issues a new print job acquisition request. On the other hand, if it receives print data (determination at step S304 is Yes), the printer P proceeds to step S306, where it performs image processing such as rendering that is required for printing the data, then starts printing.

The subsequent steps are similar to those in the embodiment described earlier. If the print result receiving module 48 of the distributed print management server 30 determines at step S504 that the print queue is empty, it broadcasts a print end notification to all printers P at step S510 before notifying the print instructing device 20 of the queue empty state (step S512). This print end notification allows the printers P to immediately perform termination check (step s314) that is required for termination, and return to a ready-to-print state and issue the next print job acquisition request (step S300).

The print starting module 44 issues a print start request and enters a predetermined wait period (step S214), after that, determines whether or not an additional job remains in the print queue. If no print job remains in the queue (the determination is No), the distributed print process ends (step S218). If a print job remains in the print queue, the process returns to step S208, where a print start notification is broadcasted, and then the process described above is repeated until all print jobs in the print queue are removed.

The entire disclosure of Japanese Patent Application Nos. 2002-379,956 filed Dec. 27, 2002 and 2003-388,845 filed Nov. 19, 2003 are incorporated by reference.

What is claimed is:

1. A distributed printing system comprising:
a print instruction device that issues a distributed print request based on print data;
a distributed print management server that divides said print data into a plurality of print jobs according to said distributed print request and stores the print jobs in a print job holding portion; and
a plurality of printers that acquire said print jobs from said distributed print management server and performs printing, wherein:
said distributed print management server identifies one of said print jobs to be printed, provides a distributed print start notification to said printers, selects from among printers that have issued an acquisition request for said identified print job a printer that is appropriate for said identified job on the basis of printing capabilities and status information of the printer, and assigns said identified print job to said selected printer.

2. A distributed printing system comprising:
a print instruction device that issues a distributed print request based on print data;
a distributed print management server that divides said print data into a plurality of print jobs according to said distributed print request and stores the print jobs in a print job holding portion; and
a plurality of printers that acquire said print jobs from said distributed print management server and performs printing, wherein:
said printers receive a print start notification from said distributed print management server and, if said printers are available for printing, provide a print job acquisition request for said print job to said distributed print management server along with the printing capability information and status information of said printers; and
said distributed print management server identifies one of said print jobs to be printed from said print job holding portion, provides said print start notification to all or some of said plurality of printers, selects from among printers that have issued said print job acquisition request a printer that is appropriate for said print job on the basis of the printing capabilities and status information of the printers, and assigns said print job to said printer.

3. A distributed printing system comprising:
a print instruction device that issues a distributed print request based on print data;
a distributed print management server that divides said print data into a plurality of print jobs according to said distributed print request and stores the print jobs in a print job holding portion; and
a plurality of printers that acquire said print jobs from said distributed print management server and performs printing, wherein:
said printers receive a print start notification from said distributed print management server and, if said printers are available for printing, provide a print job acquisition request for said print job to said distributed print management server along with the printing capability information and status information of said printers; and
each time said distributed print management server obtains one or more print jobs from said print job holding portion, said distributed print management server provides said distributed print start notification to all or some of said plurality of printers, selects one or more printers that complete the print job in the shortest time from warm-up from among printers that have issued said print job acquisition request, on the basis of printing capabilities and the status information of the printer, and assigns the print jobs to the printers.

4. A distributed printing system comprising:
a print instruction device that issues a distributed print request based on print data;
a distributed print management server that divides said print data into a plurality of print jobs according to said distributed print request and stores the print jobs in a print job holding portion; and
a plurality of printers that acquire said print jobs from said distributed print management server and performs printing, wherein:
said printers receive a print start notification from said distributed print management server and, if said printers are available for printing, provide a print job acquisition request for said print job to said distributed print management server along with the printing capability information and status information of said printers; and
each time said distributed print management server obtains a print job from said print job holding portion, said distributed print management server provides said distributed print start notification to all or some of said plurality of printers, selects a printer that completes the print job in the shortest time from print data reception from among printers that have issued said print job acquisition request, on the basis of printing capabilities and the status information of the printer, and assigns the print job to the printer.

5. A distributed printing system comprising:
a print instruction device that issues a distributed print request based on print data;
a distributed print management server that divides said print data into a plurality of print jobs according to said distributed print request and stores the print jobs in a print job holding portion; and
a plurality of printers that acquire said print jobs from said distributed print management server and performs printing, wherein:
each of said printer sends a print job acquisition request for said print job to said distributed print management server along with printing capability information and status information of said printer if said printer is available for printing; and
each time said distributed print management server obtains a print job from said print job holding portion, said distributed print management server selects printers that are available for printing from among printers that have issued said print job acquisition request, selects a printer that is appropriate for said print job from among said selected printers on the basis of printing capabilities and the status information of the printer, and assigns said print job to said printer.

6. The distributed printing system according to claim 1, wherein:
if there is no printer that is appropriate for said identified print job in said selection of an appropriate printers said distributed print management server makes said print job wait temporarily, identifies the next print job that is different from said print job, and provides a distributed print start notification for said next print job to all of said plurality of printers.

7. The distributed printing system according to claim 1, wherein, said print job holding portion is a print queue holding said print jobs in the order in which said print jobs are received.

8. The distributed printing system according to claim 1, wherein said print instructing device comprises:
an input-output interface that communicably connects to said distributed print management server;
a print data generating unit that generates print data from data to be printed and print settings that indicate printing mode of said data to be printed;
a print request issuing unit that sends a print request to said distributed print management server through said input-output interface; and
a print status display unit that receives a notification from said distributed print management server and displays a print status.

9. The distributed printing system according to claim 1, wherein said distributed print management server comprises:
an input-output interface that communicably connects to said print instructing device and each of said printers;
a print request receiving unit that receives a print request containing print data and print settings from said print instructing device;
a print data dividing unit that divides the received print data into a plurality of print jobs for distributed printing;
a print job holding portion managing unit that holds and manages the print jobs generated by dividing the print data and the correspondences of the status between the print jobs and the print data; and
a distributed printing control unit that controls distributed printing interaction between the print job holding portion management unit and the printers.

10. The distributed printing system according to claim 9, wherein said distributed printing control unit comprises:
a print starting module that issues a print start notification to said plurality of printers and receives and stores printing capability information of printers that has issued a print job acquisition request;
a print job acquisition request receiving module that receives the print. job acquisition request from said printers along with the status information of the printers and selects an optimal printer on the basis of the status information and the printing capability information to sends print data; and
a print result receiving module that receives the result of print job execution from said printer.

11. A distributed printing system comprising:
a print instructing device that generates print data and issues a distributed print request;
a distributed print management server that divides the print data into a plurality of print jobs according to the distributed print request and stores the print jobs in a print queue; and
a plurality of printers that acquire a print job from the distributed print management server and performs printing, wherein:
each time said distributed print management server obtains a print job from said print queue, said distributed print management server provides distributed print start notification to all of said printers, selects printers available for printing from among printers that have issued a print job acquisition request, selects a printer that is appropriate for said print job from among the selected printers on the basis of printing capabilities and the status information of the printers, and assigns said print job to said printer.

12. A distributed printing system comprising:
a print instructing device that generates print data and issues a distributed print request;
a distributed print management server that divides the print data into a plurality of print jobs according to the distributed print request and stores the print jobs in a print queue; and
a plurality of printers that acquire a print job from the distributed print management server and performs printing, wherein:
each time said distributed print management server obtains a print job from said print queue, said distributed print management server provides distributed print start notification to all of said printers, selects printers available for printing from among printers that have issued a print job acquisition request, selects a printer that completes the print job in the shortest time from warm-up from among the selected printers, on the basis of printing capabilities and the status information of the printer, and assigns the print job to the printer.

13. The distributed printing system according to claim 11 wherein, if there is no printer that is appropriate for a obtained print job, the print job is made wait temporarily, the next print job is obtained from the print queue, the distributed print start notification is provided to all of said printers once again, printers that are available for printing are selected from among printers that have issued a print job acquisition, a printer that is appropriate for the print job is selected from the selected printers on the basis of printing capabilities and the status information of the printers, and the print job is assigned to the printer.

14. The distributed printing system according to claim 11,
wherein said print instructing device comprises:
an input-output interface that communicably connects to said distributed print management server;
a print data generating unit that generates print data from data to be printed and print settings that indicate printing mode of the data;
a print request issuing unit that sends a print request to said distributed print management server through said input-output interface; and
a print status display unit that receives a notification from said distributed print management server and presents a print status to a user.

15. The distributed printing system according to claim 11, wherein said distributed print management server comprises:
an input-output interface that communicably connects to said print instructing device and each of said plurality of printers;
a print request receiving unit that receives a print request containing print data and print settings from said print instructing device;
a print data dividing unit that divides the received print data into a plurality of print jobs for distributed printing;
a print queue managing unit that holds and manages the print jobs generated by dividing the print data and the correspondences of the status between the print jobs and the print data; and
a distributed printing control unit that controls distributed printing interaction between the print queue management unit and the printers.

16. The distributed printing system according to claim 15, wherein said distributed printing control unit comprises:
a print starting processing unit that issues a print start notification to said plurality of printers and receives and stores printing capability information of printers that has issued a print job acquisition request;
a print job acquisition request receiving unit that receives the print job acquisition request from said printers along with the status information of the printers and selects an optimal printer on the basis of the status information and the printing capability information to send print data; and
a print result receiving unit that receives the result of print job execution from said printer.

17. Distributed printing system according to claim 11, wherein said printers comprising:
a print control unit that provides a print job acquisition request to said distributed print management server along with the printing capability information and status information of said printers if said printers are idle when said printers receive a print start notification from said distributed print management server, and controls general aspects of printing;
an image processing unit that processes print data received from said distributed print management server to generate printable data;
a printing unit that prints the printable data generated by said image processing unit; and
an input-output interface that communicably connects said print control unit, said image processing unit, and said printing unit with said distributed print management server.

18. A distributed printing method that divides print data into a plurality of print jobs and assigns one of a plurality of printers to each of said plurality of print jobs for performing distributed printing, said method comprising:
when each print job is identified, providing a distributed print start notification to all or some of said printers;
selecting a printer that is appropriate for said each print job from among printers that have issued a print job acquisition request, on the basis of printing capabilities and the status information of the printers; and
assigning said each print job to said selected printer.

19. A distributed printing method that divides print data into a plurality of print jobs and assigns one of a plurality of printers to each of said plurality of print jobs for performing distributed printing, said method comprising:
when each print job is identified, providing a distributed print start notification to all or some of the printers;
selecting a printer that completes the print job in the shortest time from warm-up from among printers that have issued a print job acquisition request, on the basis of printing capabilities and the status information of the printers; and
assigning said print job to said selected printer.

20. A distributed printing method that divides print data into a plurality of print jobs and assigns one of a plurality of printers to each of said plurality of print jobs for performing distributed printing, said method comprising:
when each print job is identified, providing a distributed print start notification to all or some of the printers;
selecting a printer that completes the print job in the shortest time from print data reception from among printers that have issued a print job acquisition request, on the basis of printing capabilities and the status information of the printers; and
assigning said print job to said selected printer.

21. A distributed printing method that divides print data into a plurality of print jobs and assigns one of a plurality of printers to each of said plurality of print jobs for performing distributed printing, said method comprising:
when each print job is identified, selecting printers that are available for printing from among printers that have issued a print job acquisition request; and
selecting a printer that is appropriate for said print job from among said selected printers on the basis of printing capabilities and the status information of the printers; and
assigning said print job to said printer.

22. The distributed printing method according to claim 18, wherein, if there is no printer that is appropriate for said identified print job, said print job is made wait temporarily, the next print job that is different from said print job is obtained, and a distributed print start notification is provided to all or some of said printers.

23. A distributed printing method that divides print data into a plurality of print jobs and assigns one of a plurality of printers to each of said plurality of print jobs for performing distributed printing, said method comprising:
each time a print job is obtained, a distributed print start notification is provided to all of said printers;
selecting printers available for printing from among printers that have issued a print job acquisition request;
selecting a printer that is appropriate for the print job from among the selected printers, on the basis of printing capabilities and the status information of the selected printers; and
assigning the print job to the printer.

24. A distributed printing method that divides print data into a plurality of print jobs and assigns one of a plurality of printers to each of said plurality of print jobs for performing distributed printing, said method comprising:
each time a print job is obtained, a distributed print start notification is provided to all of said printers;
selecting printers available for printing from among printers that have issued a print job acquisition request;
selecting a printer that completes the print job in the shortest time from warm-up from among the selected printers, on the basis of printing capabilities and the status information of the selected printers; and
assigning the print job to the printer.

25. The distributed printing method according to claim 23 wherein, if there is no printer that is appropriate for a obtained print job, the print job is made wait temporarily, the next print job is obtained from the print queue, the distributed print start notification is provided to all of said printers once again, printers that are available for printing are selected from among printers that have issued a print job acquisition, a printer that is appropriate for the print job is selected from the selected printers on the basis of printing capabilities and the status information of the printers, and the print job is assigned to the printer.

26. A distributed printing program used in a distributed printing system comprising:
a print instruction device that issues a distributed print request based on print data;
a distributed print management server that divides said print data into a plurality of print jobs according to said distributed print request and stores the print jobs in a print job holding portion, and
a plurality of printers that acquire said print jobs from said distributed print management server and performs printing, wherein:
said program causes a computer of each of said printers to receive a print start notification from said distributed print management server and, if said printer is available for printing, provide a print job acquisition request to said distributed print management server along with the printing capability information and status information of said printer; and
said program causes a computer of said distributed print management server to:
identify said print job to be printed from said print job holding portion;
provide distributed print start notification to all or some of said plurality of printers;
select from among printers that have issued a print job acquisition request a printer that is appropriate for said print job on the basis of printing capabilities and the status information of the printer; and
assign said print job to said printer.

27. A distributed printing program used in a distributed printing system comprising:
a print instruction device that issues a distributed print request based on print data;
a distributed print management server that divides said print data into a plurality of print jobs according to said distributed print request and stores the print jobs in a print job holding portion; and
a plurality of printers that acquire said print jobs from said distributed print management server and performs printing, wherein:
said program causes a computer of each of said printers to receive a print start notification from said distributed print management server and, if said printer is available for printing, provide a print job acquisition request to said distributed print management server along with the printing capability information and status information of said printer; and
said program causes a computer of said distributed print management server to:
provide distributed print start notification to all or some of said plurality of printers each time said distributed print management server obtains a print job from said print job holding portion;
select from among printers that have issued a print job acquisition request a printer that completes the print job in the shortest time from warm-up, on the basis of printing capabilities and the status information of the printer; and
assign said print job to said printer.

28. A distributed printing program used in a distributed printing system comprising:
a print instruction device that issues a distributed print request based on print data;
a distributed print management server that divides said print data into a plurality of print jobs according to said distributed print request and stores the print jobs in a print job holding portion; and
a plurality of printers that acquire said print jobs from said distributed print management server and performs printing, wherein:
said program causes a computer of each of said printers to receive a print start notification from said distributed print management server and, if said printer is available for printing, provide a print job acquisition request to said distributed print management server along with the printing capability information and status information of said printer; and
said program causes a computer of said distributed print management server to:
provide distributed print start notification to all or some of said plurality of printers each time said distributed print management server obtains a print job from said print job holding portion;
select from among printers that have issued a print job acquisition request a printer that completes the print job in the shortest time from print job reception, on the basis of printing capabilities and the status information of the printer; and
assign said print job to said printer.

29. A distributed printing program used in a distributed printing system comprising:
a print instruction device that issues a distributed print request based on print data;
a distributed print management server that divides said print data into a plurality of print jobs according to said distributed print request and stores the print jobs in a print job holding portion, and
a plurality of printers that acquire said print jobs from said distributed print management server and performs printing, wherein:
said program causes a computer of each of said printers to provide a print job acquisition request to said distributed print management server along with the printing capability information and status information of said printer if said printer is available for printing; and
said program causes a computer of said distributed print management server to:
select printers that are available for printing from among printers that have issued said print job acquisition request beforehand each time said distributed print management server obtains a print job from said print job holding portion;
select a printer that is appropriate for said print job from among said selected printers on the basis of printing capabilities and the status information of the printers; and
assign said print job to said printer.

30. A distributed printing program for causing a computer to function as comprising:
a print instructing section that generates print data and issues a distributed print request;
a distributed print managing section that divides the print data into a plurality of print jobs according to the distributed print request and stores said print jobs in a print queue; and
a plurality of print controlling sections that obtain a print job from said distributed print managing section and causing printing, wherein:
said distributed print managing section further includes the function of, when said distributed print managing section receives said distributed print request:
providing a distributed print start notification to all of said print controlling section;
selecting a print controlling section that is appropriate for printing the print job from among print controlling section that have issued a print job acquisition request; and
sending the job to said print controlling section.

31. A distributed printing program for causing a computer to function as comprising:
a print instructing section that generates print data and issues a distributed print request;
a distributed print managing section that divides the print data into a plurality of print jobs according to the distributed print request and stores said print jobs in a print queue; and
a plurality of print controlling sections that obtain a print job from said distributed print managing section and causing printing, wherein:
said distributed print managing section further includes the function of, when said distributed print managing section receives said distributed print request:
providing a distributed print start notification to all of said print controlling section;
selecting a print controlling section that completes the print job in the shortest time from warm-up from among print controlling section that have issued a print job acquisition request; and
sending the job to said print controlling section.

32. A printer connected to a distributed print management server dividing print data into plurality of print jobs and storing the print jobs through a network, wherein:
said printer receives a print start notification from said distributed print management server and, if said printer is available for printing, provides a print job acquisition request for said print job to said distributed print management server along with the printing capability information and status information of said printer.

33. A printer management server that is connected to a plurality of printers through a network, divides print data into a plurality of print jobs and stores the print jobs, wherein:
said printer management server:
identifies one of said print jobs to be printed;
provides said distributed print start notification to all or some of said plurality of printers;
selects from among printers that have issued an acquisition request for said print job a printer that is appropriate for said print job on the basis of printing capabilities and status information of the printers; and
assigns said print job to said printer.
